(19) United States
(12) Patent Application Publication
(10) Pub. No.: US 2009/0116355 A1
(43) Pub. Date: May 7, 2009

(54) METHOD AND APPARATUS FOR ACCESSING A DISC

(75) Inventor: Willem Frederik Van Der Vecht, Waalre (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/300,149

(22) PCT Filed: May 3, 2007
(86) PCT No.: PCT/IB07/51658

§ 371 Date: Nov. 10, 2008

(30) Foreign Application Priority Data
May 9, 2006 (EP) 06113717.0

(51) Int. Cl. G11B 27/36

(52) U.S. Cl. 369/53.21; G9B/27.052

(57) ABSTRACT

A record carrier of rewritable type, such as a BD-RE, is operable to perform multiple write operations. Optionally, such a record carrier can nevertheless be treated as a one time recordable record carrier, opening new opportunities for the users, like for example offering a level of protection of user-data therein recorded against unintentional subsequent erasure. The apparatus and method according to the invention enable the logical formatting of the BD-RE disc as a BD Write Once disc.

The invention relates to a method for accessing a record carrier which may be of either recordable or rewritable type, comprising:

receiving the record carrier,

establishing the type of the record carrier, and

regulating access to the record carrier in dependence of its type.

The invention further relates to an apparatus for accessing a record carrier which may be of either recordable or rewritable type, comprising:

a receiving unit for receiving the record carrier,

a recognition unit for establishing the type of the record carrier, and

an access control unit to regulate access of the record carrier in dependence of its type.

Record carriers, like for example optical discs can bear prerecorded information, i.e. be of read-only type for the user, or be recordable by the user; record carriers recordable by the user can be in particular, multiple times recordable, hereinafter referred as rewritable, or single time recordable, hereinafter simply referred as recordable. Examples are the CD, DVD and BD media families, with their respective ROM, recordable and rewritable versions: that is CD-ROM, CD-R, CD-RW for the CD family; DVD-ROM; DVD+R DVD+RW for the DVD family; and BD-ROM, BD-R and BD-RE for the BD family. A recording/playback apparatus has generally to enable different types of access to different types of record carrier, that is: only read access for ROM; read and write for recordable; read, write and erase (or overwrite) for rewritable. In order to do that the recording/playback apparatus, once a record carrier has been received, needs first to establish its type, ROM, recordable or rewritable: this action goes under the name of disc recognition. The type of a record carrier may be established by looking at some of its physical features; in some cases however the information on the type of the record carrier can be present on the record carrier itself at a conventional location and/or in a special information channel, therefore the recording/playback apparatus can establish the type of the record carrier by acquiring this information from the record carrier itself. Once the recording/playback apparatus is aware of the type of the record carrier, accesses to the record carrier are controlled in dependence of said type, as this is of paramount importance to avoid misuse of the record carrier: a write operation must not be possible on a ROM and an erase operation must not be possible on a recordable or ROM disc, both to prevent damages to the record carrier an not to mislead a user about the type of access that is actually taking place.

It has to be remarked that controlling the access to an record carrier in dependence of its type has a wider meaning than simply granting or not granting e.g. an erase action, but more in general accessing the record carrier in compliance with the rules specified for that type of record carrier, concerning e.g. the areas where user-data can or cannot be recorded, or the location of access data (i.e. a list of the objects recorded on the record carrier and pointers to said objects), and so forth. This is sometimes referred as “formatting” the record carrier, i.e. laying down data according to a format foreseen for that type of record carrier. Consequently, during disc recognition, if it is observed that data have already been laid down according to a format foreseen for a given type of record carrier, e.g. access information is present at a particular location which fact is peculiar of the format foreseen for the given type of record carrier, this can be taken as an indication that the record carrier is of the given type, dispensing from the need to look at the physical features of such record carrier.

Coming now specifically to optical discs belonging to the BD family, of type recordable by the user, for BD-R discs, certain aspects of the laying down of data are defined in a document named “System Description Blu-ray Disc Recordable Format, Part 1, Basic Format Specifications, version 1.11, December 2005”. It is prescribed that a so-called Temporary Disc Management Area (TDMA), comprising access data, has to be present at sector address ee060 for single layer discs, or ee0c0 for double layer discs. The same sectors are reserved according to the BD-RE format. Therefore if a TDMA is present, recognisable by its specific TDMA contents (also defined by the same specification), the disc can be recognized as a BD Recordable.

Any particular location on a BD-R disc cannot be written more than once. This is because the state change of the sensitive layer, which is caused when writing onto it, is irreversible. In contrast, the state change of the BD-RE sensitive layer is reversible, thus allowing a BD-RE disc to be written more than once. For a BD-R disc the TDMA update units are written sequentially in the TDMA area, whereas for a BD-RE disc so-called DMA update units are used as control data, which can be written at the same location over and over again. It is noted that the DMA update units of a BD-RE disc are never located in the areas starting at ee060 (or ee0c0), which correspond to those allocated for the TDMA area of a BD-R disc. In other words, according to the BD-RE standard these areas are reserved.

It is noted that the standard also provides a mechanism whereby a BD Recordable disc can be used as if it were a BD Rewritable disc. This is accomplished using the so called Logical Overwrite mechanism (known as Pseudo Overwrite, POW, in the Blu-ray Disc Multi-Media Command Set Description (MMC), e.g. draft version 0.60, 14 Aug. 2005). Of course, since the state change of the sensitive layer in a BD-R disc is irreversible, the Pseudo Overwrite does not actually overwrite the same physical location on the disc. Instead, when an application or host device provides a write command to an already written location, the POW operation enables a drive to write the new data to a different, unwritten, location. This replacement is recorded in the so-called defect table, which is also used for replacement in the case of defective areas.

It is an object of the present invention to provide a method and an apparatus for accessing a record carrier, of the types described in the opening paragraph, which allow a more flexible use of the record carrier.

This object is achieved according to the invention by a method as claimed in claim 1 and an apparatus as claimed in claim 11.

The use of a Rewritable record carrier of rewritable type as if it where a recordable type has several advantageous applications.

First, the invention can be applied for providing a level of protection of data recorded on a rewritable media against their unintentional or unwanted erasure, especially when the data recorded on the record carrier are intended for archiving. For some types of record carriers, like e.g. optical discs, this is particularly interesting because rewritable record carriers are guaranteed to retain data longer that recordable record carriers. Further, the invention can be applied to enable a write operation to a rewritable disc to be performed at an increased speed when the disc is operated as if it was of recordable type, as will be explained in greater detail below. Furthermore, should the cost of rewritable discs become lower than the cost of recordable discs due to increased volume of sales, the invention would have the advantage of enabling lower cost rewritable discs to be used as recordable discs in applications that require the use of a recordable disc.

Advantageous embodiments of the invention are claimed in the dependent claims.

To help clarify the understanding of the invention, and to explain more fully how the invention may be put into effect, reference will now be made, by way of example only, to the following drawings in which:

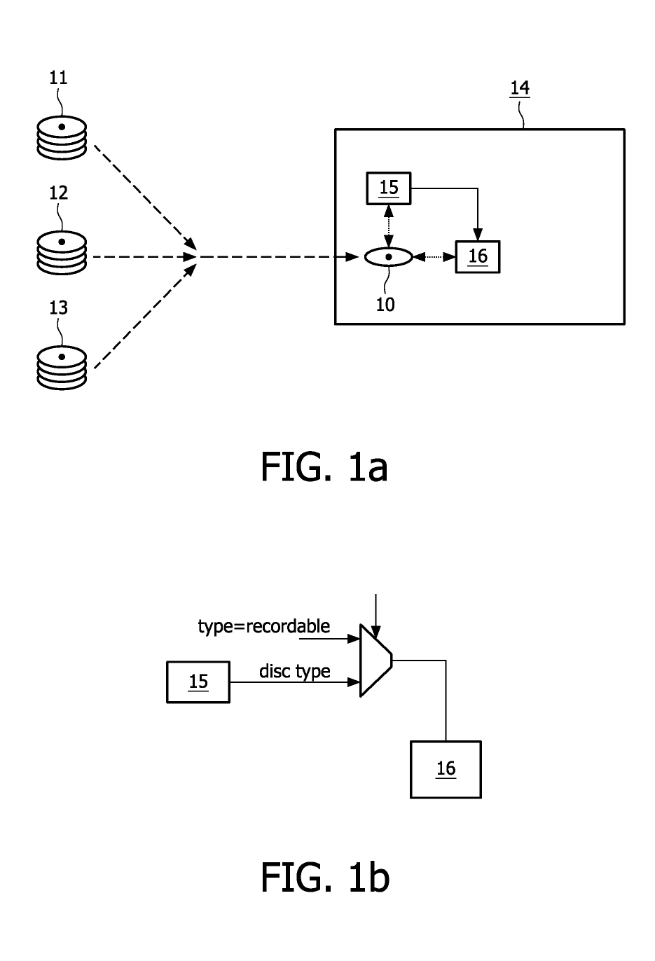

FIG. 1a shows an apparatus for accessing record carriers which can be of ROM, recordable or rewritable type,

FIG. 1b shows a detail of the apparatus shown in FIG. 1a, adapted according to the invention,

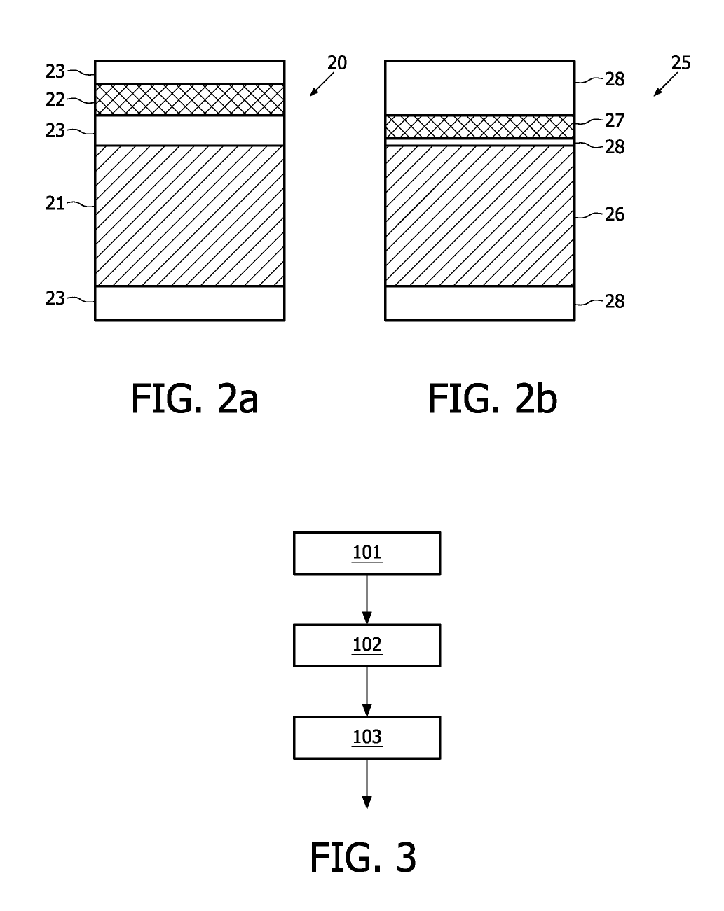

FIGS. 2a and 2b show schematically the memory space of respectively a recordable and a rewritable record carrier, and

FIG. 3 shows an embodiment a method, according to the present invention, of accessing a record carrier of rewritable type.

FIG. 1a shows an apparatus for accessing record carriers which can be of ROM, recordable or rewritable type. A record carrier 10, which can be taken from a group of record carriers of rewritable type 11, or from a group of record carriers of recordable type 12, or even from a group of record carriers of ROM type 13, is inserted in an apparatus 14. The apparatus comprises a recognition unit 15 for establishing which is the type of the record carrier 10, that is ROM, recordable or rewritable. Once this has been established, this information is passed to an access control unit 16 which regulates access to the record carrier in accordance to its type. This means first of all the for a given type of record carrier, only those accesses which are physically compatible with the given type have to be allowed: only read accesses for ROM; read and write on recordable; read, write and erase for rewritable. The reasons why write access must not be exercised on a ROM record carrier, and erase must not be attempted on a ROM or recordable record carrier are that they would not have the desired result anyway, thereby misleading the user, and may cause damage of the record carrier and corruption of data recorded thereon. Conversely it is equally important that write access is granted to a recordable or rewritable record carrier, and erase (or overwrite) is allowed for a rewritable record carrier, otherwise these record carriers could not be fully exploited.

In addition, regulating access to a record carrier according to its type also means that when data are recorded they have to be recorded in accordance to what specified for the relevant type of record carrier, for example where user data have or don't have to be recorded, and where and how control information, and in particular access information has to be recorded.

This can be better understood in reference to FIGS. 2a and 2b which show schematically the memory space of respectively a recordable and a rewritable record carrier. In FIG. 2a it is represented the storage space of a recordable record carrier 20, comprising a user data area 21, an access data area 22, and one or more reserved areas 23. Similarly in FIG. 2b it is represented the storage space of a recordable record carrier 25, comprising a user data area 26, an access data area 27, and one or more reserved areas 28. In the example shown in this Fig. the access data area 22 in the storage space of a recordable record carrier 20 is located at addresses, which, in the storage space of a recordable record carrier 25, correspond to a reserved area 28; this is the case when considering for example BD-R versus BD-RE.

The access data is intended as data which identifies the content present on the disc, e.g. a directory of files with respective names, initial addresses and other attributes.

Some details are now given of how the access information is recorded on BD-R and BD-RE.

A BD-R disc may have many sessions with many tracks. Track entries are recorded in the so-called SRRI (Sequential Recording Range Information) where SRR (Sequential Recording Range) is the word for “track” in the BD standards. An SRRI is embedded in a so-called TDMS update unit. TDMS means Temporary Disc Management Structure, and the TDMS update units are written consecutively in the TDMA, which means Temporary Disc Management Area. “Temporary” refers to the fact that the disc is not closed. When closing the disc the final copy is called DMS and the area where is goes is the DMA. One TDMS update unit contains 3 items:

### the TDDS (Temporary Disc Definition Structure)

### the SRRI (Sequential Recording Range Information)

### the DFL (Defect List)

The TDDS contains general information about the disc, including pointers to the DFL and SRRI, but also general information such as “Location of Logical Sector Number 0 of User Data Area”, “Last Logical Sector Number of User Data Area”, or “Last Recorded Address of User Data Area”. The TDMA starts at cluster address (hexadecimal) ee060. Every time the SRRI or the DFL is updated, a new TDMS update unit is written. On a BD-RE the area starting at cluster address (hexadecimal) ee060 is reserved.
A BD-RE disc has a structure called DMS (Defect Management Structure) which is similar to TDMS on a BD-R. A DMS contains 2 items:

### the DDS (Disc Definition Structure)

### the DFL (Defect List)

The DMS resides in the DMA (Defect Management Area). More precisely: the disc has four copies, called DMA1, DMA2, DMA3, DMA4, for robustness, at addresses as specified in the Basic Format Specification. A DMS does not contain something like an SRRI, because according to the Basic Format Specification, a BD-RE only has one track (that could be thought of as contained in the one and only session, and covering the entire User Data Area). The DDS has entries like “Location of Logical Sector Number 0 of User Data Area” and “Last Logical Sector Number of User Data Area”. A concept such as Last Recorded Address is not encompassed, because a BD-RE is a randomly writable medium, and the application layer (file system, video format etc.) determine how to use the User Data Area.
At the MMC command level the same kind of information can be requested for a BD-RE disc as for a BD-R disc, like what is the number of tracks and sessions (which in this case is always one).

FIG. 1b schematically shows how the apparatus shown in FIG. 1a is adapted according to the invention: the information on the type of record carrier which can be recordable, rewritable or ROM, and which is normally passed by the recognition unit 15 to the access control unit 16, can in some circumstances be overruled and be set to “recordable”. Clearly the means to overrule the type of record carrier can equally be implemented in software or in hardware or a combination thereof. The control signal to overrule the type of record carrier can be generated outside the apparatus, for example if the apparatus has the form of an optical disc drive, then said control signal can be passed form an application program, upon an option expressed by a user.

Preferably, the invention is implemented as part of the firmware in the disc drive. In particular, the Format Unit command is adapted to accept the format types for BD Recordable media in case of a BD Recordable disc as well as in case of a BD Rewritable disc. The Format Unit has a parameter (the format type) that specifies the logical format that the drive must write onto the disc. For an unformatted (i.e. brand-new) BD-RE disc, format type 32 (BD-R) would not normally be acceptable. However, according to the invention format type 32 is made acceptable for a BD-RE disc.

In a typical disc drive, when a disc is inserted, the drive recognises the type of the disc by doing one or more of the following:

assessing the physical features of the disc,

acquiring the information on the type of the disc from the disc itself, if that is known to be present in the disc,

observing the presence or absence of certain control information at certain locations or in certain physical variations, or

observing that the information previously recorded on the disc is compliant with a particular type, and incompatible with other types of discs.

For the latest item an example is the TDMA area mentioned above. Normally, when the disc inserted in the disc drive is a BD Rewritable disc, the disc will be recognised as such by the absence of data in the TDMA data area. Likewise, when writing data to a rewritable disc, a Format Unit (being an MMC command) given to the drive by the application or host device, will have parameters that indicate that the currently inserted disc must have the format BD-RE.

FIG. 3 shows an embodiment of a method, according to the present invention, of accessing a record carrier of rewritable type. In a first step 101 a rewritable record carrier is received; in a second step 102 rewritable type of the record carrier is recognized; in a third step 103 the drive overrides the information as to type of the record carrier being rewritable and regulates access to the record carrier as if it were of recordable type, for example, in case of a BD, it allows an application or host device to format a BD Rewritable disc (i.e. the physical BD-RE disc) as if it was a BD recordable. In other words, a Format Unit command given to the drive from an application or host device will have parameters that specify that the drive must format the disc with a logical BD-R format, even if there is a physical BD-RE disc inserted in the drive. Thus, the drive will thereafter “see” or “treat” the media as a formatted BD Recordable disc.

This means in particular that the BD Rewritable disc is “formatted” by writing certain control data, a TDMA pattern, to a predetermined area, the TDMA area, on the BD Rewritable disc, which would normally be a prerogative for Recordable discs. For a single layer disc the TDMA pattern is written to address ee060, for a double layer disc the TDMA pattern is written to address ee0c0. It will be appreciated that the data can be written to other areas of a disc, depending on the area normally used to store this information on a conventional BD Recordable disc. In this way the Rewritable disc has been formatted as a recordable.

Upon re-loading such disc in the same or a similar drive, the disc may, in accordance with the disc recognition algorithm used, be recognised as a BD-R. This is the case if the disc drive inspects the appropriate address to determine if a TDMA pattern is present, and if the TDMA pattern is present, the disc drive derives that the disc is a BD-RE. In the event that the drive is confronted with a physical BD-RE, which has been previously formatted as recordable, several options are possible.

According to an embodiment of the invention, the functionality of the disc drive is implemented such that it prevents re-formatting of such a disc by a successive Format Unit command. In this way, the disc drive does not accept successive Format Unit commands, so the disc cannot be re-formatted, just like for real BD-R discs. This embodiment can be applied for example for implementing a layer of protection of data recorded on the disc against their unintentional, uncontrolled or unwanted alteration.

According to an alternative embodiment of the invention, the functionality of the disc drive is implemented such that it allows re-formatting by a successive Format Unit command, possibly upon a confirmation from the user. In other words, the provision of making the BD rewritable disc appear as a BD-R can be reverted, such that data contained on the disc can be overwritten again at a later stage, thereby making the disc re-usable. In this way the behaviour of the disc drive with respect to re-formatting is different for (1) proper BD Recordable discs which can never be reformatted, and (2) for BD Rewritable discs formatted as BD Recordable which can successively be reformatted. In other words, once a BD-RE disc has been formatted as a BD-R, the disc can be re-formatted again as a BD-RE. Thus, the apparatus must be enabled to distinguish the rewritable nature of the disc apart from the way how the disc has been formatted.

For this re-format all BD-R format commands (defined in MMC) are acceptable, since the drive treats the disc as a BD-R. This includes format type 0, which gives the default format for a BD-R disc. It is noted that, on an unformatted BD-RE disc or a BD-RE disc with already a BD-RE format, format type 0 would result in a default BD-RE format.

This provides an advantage for application development, for example in the case of a software program running on a computer that has the functionality of writing data on an optical disc. For instance, Nero Burning ROM is an application that can be used to make a backup of user documents or photographs on a DVD, or to create an audio CD with the user's favourite music. When the manufacturer of an application such as Nero Burning ROM wishes to extend the program to support Blu-ray discs, then the invention enables the manufacturer to test the new support for BD-R discs using BD-RE discs as if they were BD-R discs, such that the manufacturer does not need to throw away full or mis-recorded discs. This is made possible by the fact that the invention allows BD-R formatted BD-RE discs to be re-formatted.

The apparatus can be adapted to re-format BD-RE disc previously formatted as recordable by physically erasing the access data that has been written on the disc, i.e. in the TDMA area, or, alternatively, the by logically erasing the access data that has been written on the disc, i.e. by de-allocating the area where the access data has been recorded.

In practice the apparatus can be adapted to store the Next Writable Address (NWA), referring to the cluster address where a recorded area switches to an unrecorded area. The apparatus would detect the end of the control structures (such as the TDMA area) by reading rather than by searching for a recorded-unrecorded transition. When re-formatting, the apparatus would record a new initial control data structure (such as a TDMA update unit) and the NWA as the address immediately following the first update unit.

As will be appreciated from the above, applications or host devices that wish to use a BD Recordable format on a disc are no longer forced to use BD Recordable media, but can also use a BD Rewritable media in the drive.

Also, the invention has the advantage of potentially enabling a write operation to a Rewritable disc to be performed at an increased speed when the disc is treated as a Recordable. In fact, if a BD Rewritable disc is written only once, there is no need to erase any recorded marks and the recording speed of the disc can therefore be increased. This is because the step of erasing the previously recorded marks is the limiting factor of the writing speed (i.e. during erase, an amorphous mark will go to the crystalline state, and the speed at which this can happen will depend on the physical properties of the recording layer). As such, a BD Rewritable disc formatted for rewritable use could be written to at a first speed “×”, while a BD Rewritable disc formatted for recordable use could be written to at a second speed, for example “2×” (provided, of course, that this the disc is blank). This is made possible by omitting the erase action (that erases the existing data) before writing or dispensing from the need to keep the laser at an erase level between successive marks. It is also possible that writing a BD-RE disc without erase, i.e. a logical BD-R format, can be faster than writing a physical (i.e. real) BD-R disc.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

1. A method for accessing a record carrier (10) which may be of either recordable or rewritable type, comprising:
receiving the record carrier (101),
establishing the type of the record carrier (102), and
regulating access to the record carrier in dependence of its type (103), characterized by, if the record carrier is of rewritable type, overriding the record carrier type and regulating access to the record carrier as if it were of recordable type.

2. A method as claimed in claim 1, wherein regulating access to the record carrier as if it were of recordable type comprises formatting the rewritable record carrier as if it were of recordable type.

3. A method as claimed in claim 2, formatting the rewritable record carrier as if it were of recordable type comprises writing access data at a predetermined address, which predetermined address corresponds to a reserved area for a record carrier of rewritable type.

4. A method as claimed in claim 3, wherein the record carrier belongs to the BD family, and the predetermined address correspond to ee060 for a single layer disc and ee0c0 for a double layer disc.

5. A method as claimed in claim 3, wherein the step of establishing the type of the record carrier comprises verifying if access data is present at the predetermined address.

6. A method as claimed in claim 3, wherein further re-formatting of the record carrier as rewritable is prevented.

7. A method as claimed in claim 3, further comprising re-formatting the record carrier as rewritable.

8. A method as claimed in claim 7, wherein re-formatting of the record carrier as rewritable comprises the step of physically erasing existing access data.

9. A method as claimed in claim 7, wherein re-formatting of the record carrier as rewritable comprises the step de-allocating an area containing existing access data.

10. A method as claimed in claim 1, wherein regulating access to the record carrier as if it were of recordable type comprises using a writing speed higher than the maximum writing speed foreseen for rewritable type.

11. An apparatus (14) for accessing a record carrier (10) which may be of either recordable or rewritable type, comprising:
a receiving unit for receiving the record carrier,
a recognition unit (15) for establishing the type of the record carrier, and
an access control unit (16) to regulate access of the record carrier in dependence of its type,
characterized by being adapted to, if the record carrier is of rewritable type, override the record carrier type and regulate access to the record carrier as if it were of recordable type.
